(19) United States
(12) Patent Application Publication
(10) Pub. No.: US 2026/0346212 A1
(43) Pub. Date: Nov. 5, 2026

(54) SUBSTRATE FOR LIQUID FILTER

(71) Applicant: TEIJIN LIMITED, Osaka-shi, Osaka (JP)

(72) Inventor: Yu NAGAO, Osaka-shi, Osaka (JP)

(73) Assignee: TEIJIN LIMITED, Osaka-shi, Osaka (JP)

(21) Appl. No.: 18/997,895

(22) PCT Filed: Jul. 27, 2023
(86) PCT No.: PCT/JP2023/027633

§ 371 Date: Jan. 23, 2025

(30) Foreign Application Priority Data
Jul. 28, 2022 (JP) 2022-120889

(51) Int. Cl. B01D 71/26; B01D 69/02

(52) U.S. Cl. CPC B01D 71/261; B01D 69/02; B01D 2325/02832; B01D 2325/02833; B01D 2325/04

(57) ABSTRACT

A substrate for a liquid filter includes a polyolefin microporous membrane, in which an average value of pore diameters of the polyolefin microporous membrane is from 1 nm to 50 nm, an average value of water flow rates of the polyolefin microporous membrane is from 0.003 L/min/ft²/psi to 0.180 L/min/ft²/psi, and a coefficient of variation in water flow rate of the polyolefin microporous membrane is 0.100 or less.

### TECHNICAL FIELD

The present disclosure relates to a substrate for a liquid filter.

### BACKGROUND ART

In recent years, electronic devices are becoming increasingly smaller with higher performance. In particular, digital devices and portable terminals, as typified by personal computers and smartphones, have been dramatically developed. Among various techniques leading and supporting such development, as is well known, technological innovation in the semiconductor industry has played a major role. In the recent semiconductor industry, the development race is going on in the field where the wiring pattern dimension is below 10 nm, and the manufacturers have been accelerating the construction of cutting-edge production lines

A lithography step is a step of forming a pattern in the production of semiconductor parts. With the recent development of finer patterns, an extremely high level of technology has been required not only in terms of the nature of a liquid chemical used in a lithography step itself but also for the handling of the liquid chemical prior to application onto a wafer.

A liquid chemical prepared at a high level is filtered through a dense liquid filter immediately before application onto a wafer to remove minute foreign matters and gel-like foreign matters derived from the liquid chemical that greatly affect the pattern formation or yield. In the cutting-edge formation of wiring patterns having a pattern size of less than 10 nm, as the wiring pattern size is miniaturized to from 10 nm to several nm, a liquid filter having both a finer pore diameter and favorable permeability is required in order to collect fine foreign matters of 5 nm or less in the liquid chemical. Therefore, filter manufacturers are vigorously advancing the development of a liquid filter for an advanced semiconductor.

As a substrate for a liquid filter applicable to a dense liquid filter, a substrate for a liquid filter including a polyolefin microporous membrane having a small pore diameter is known (see, for example, Patent Literatures 1 to 7).
Patent Literature 1: Japanese Patent Application Laid-Open (JP-A) No. 2014-218563
Patent Literature 2: JP-A No. 2014-217800
Patent Literature 3: Japanese Patent Publication (JP-B) No. 5684951
Patent Literature 4: JP-B No. 5684952
Patent Literature 5: JP-B No. 5684953
Patent Literature 6: JP-A No. 2018-167198
Patent Literature 7: JP-B No. 6805371

### SUMMARY OF INVENTION

### Technical Problem

In the substrate for a liquid filter having a finer pore diameter of 50 nm or less, a problem of variation in filtration time in the width direction of the substrate for a liquid filter is likely to occur. In a case in which the filtration time of the liquid filter is not uniform, the pressure applied in the width direction of the filter tends to be non-uniform, for example, a low pressure at the center portion of the filter and a high pressure at the end of the filter, and the liquid cannot be uniformly filtered through the entire filter. As a result, there is a concern that the filter performance and the filtration life are reduced, or the manufacturing yield of a semiconductor is reduced.

The disclosure has been made in view of the above conventional problems, and an object thereof is to provide a substrate for a liquid filter capable of suppressing variation in filtration time even with a small pore diameter.

### Solution to Problem

Specific means for attaining the above object are as follows.
<1> A substrate for a liquid filter, including a polyolefin microporous membrane,
in which an average value of pore diameters of the polyolefin microporous membrane is from 1 nm to 50 nm,
an average value of water flow rates of the polyolefin microporous membrane is from 0.003 L/min/ft²/psi to 0.180 L/min/ft²/psi, and
a coefficient of variation in water flow rate of the polyolefin microporous membrane is 0.100 or less.
<2 The substrate for a liquid filter described in <1>, in which a coefficient of variation in pore diameter of the polyolefin microporous membrane is 0.100 or less.
<3> The substrate for a liquid filter described in <1> or <2>, in which a coefficient of variation in membrane thickness of the polyolefin microporous membrane is 0.100 or less.
<4> The substrate for a liquid filter described in any one of <1> to <3>, in which a coefficient of variation in porosity of the polyolefin microporous membrane is 0.100 or less.
<5> The substrate for a liquid filter described in any one of <1> to <4>, in which an average value of membrane thickness of the polyolefin microporous membrane is from 3 μm to 20 μm.
<6> The substrate for a liquid filter described in any one of <1> to <5>, in which an average value of porosity of the polyolefin microporous membrane is from 35% to 60%.

### Advantageous Effects of Invention

According to the disclosure, it is possible to provide a substrate for a liquid filter capable of suppressing variation in filtration time even with a small pore diameter.

### DESCRIPTION OF EMBODIMENTS

Hereinafter, embodiments of the disclosure will be described in detail. However, the disclosure is not limited to the following embodiments. In the following embodiments, constituent elements (including elemental steps and the like) are not necessarily indispensable unless otherwise stated. The same applies to numerical values and ranges thereof, and does not limit the disclosure.

In the disclosure, the term “step” includes not only a step independent of other steps but also a step by which an action of the step is achieved, though the step cannot be clearly distinguished from other steps.

In the disclosure, a numerical range that has been indicated by use of “to” includes the numerical values which are described before and after “to”, as a minimum value and a maximum value, respectively.

In a numerical range described in a stepwise manner in the disclosure, an upper limit value or a lower limit value described in one numerical range may be replaced with an upper limit value or a lower limit value described in another numerical range described in a stepwise manner. In a numerical range described in the disclosure, an upper limit value or a lower limit value of the numerical range may be replaced with a value shown in Examples.

In the disclosure, each component may contain a plurality of corresponding substances. In a case in which a plurality of substances corresponding to each component are present in the composition, the content ratio or content of each component means the total content ratio or content of the plurality of substances present in the composition unless otherwise specified.

In the disclosure, the term “layer” or “membrane” includes, in a case in which a region in which the layer or the membrane is present is observed, not only a case in which the layer or the membrane is formed over an entire area of the region, but also a case in which the layer or the membrane is formed only in a part of the region.

In the disclosure, regarding a polyolefin microporous membrane, the term “longitudinal direction” means a longitudinal direction of the polyolefin microporous membrane produced in an elongated shape, and the term “width direction” means a direction perpendicular to the longitudinal direction of the polyolefin microporous membrane. Hereinafter, the “width direction” is also referred to as “TD”, and the “longitudinal direction” is also referred to as “MD”.

The “width direction” in a substrate for a liquid filter means the same direction as the direction perpendicular to the longitudinal direction in the polyolefin microporous membrane.

### [Substrate for Liquid Filter]

A substrate for a liquid filter of the disclosure is a substrate for a liquid filter, including a polyolefin microporous membrane, in which an average value of pore diameters of the polyolefin microporous membrane is from 1 nm to 50 nm, an average value of water flow rates of the polyolefin microporous membrane is from 0.003 L/min/ft²/psi to 0.180 L/min/ft²/psi, and a coefficient of variation in water flow rate of the polyolefin microporous membrane is 0.100 or less.

According to the substrate for a liquid filter of the disclosure, variation in filtration time can be suppressed even with a small pore diameter. The reason is not clear, but is presumed as follows.

In the substrate for a liquid filter of the disclosure, since the average value of water flow rates of the polyolefin microporous membrane is from 0.003 L/min/ft²/psi to 0.180 L/min/ft²/psi, not only the water permeation efficiency as a liquid filter is likely to be sufficiently obtained, but also the stability of solution feeding through the filter is likely to be obtained over a long period of time. In the substrate for a liquid filter of the disclosure, since the average value of pore diameters of the polyolefin microporous membrane is from 1 nm to 50 nm, sufficient liquid permeability can be obtained, and fine particles of, for example, about 10 nm or less can be extremely highly collected. From the above, it is presumed that the substrate for a liquid filter of the disclosure can effectively function as a liquid filter for an advanced semiconductor.

In a case in which the average value of pore diameters of the polyolefin microporous membrane is as small as 50 nm or less, the filtration time tends to vary in the width direction of the substrate for a liquid filter. However, in the disclosure, since the coefficient of variation in water flow rate of the polyolefin microporous membrane is 0.100 or less, it is presumed that the pressure applied in the width direction of the filter is less likely to be non-uniform, and the variation in filtration time is suppressed.

As described above, according to the substrate for a liquid filter of the disclosure, it becomes easy to uniformly filter a liquid through the entire filter, and as a result, deterioration in filter performance and reduction in filtration life tend to be easily suppressed.

### (Polyolefin Microporous Membrane)

The substrate for a liquid filter of the disclosure includes a polyolefin microporous membrane. The substrate for a liquid filter of the disclosure may be a substrate including only a polyolefin microporous membrane, or may be a substrate in which a polyolefin microporous membrane and another layer (for example, a coating layer or a porous substrate) are layered. The polyolefin microporous membrane may be a layered membrane having a structure in which a plurality of polyolefin porous layers are layered.

The polyolefin microporous membrane is a microporous membrane containing polyolefin. Here, the microporous membrane means a membrane having a large number of micropores inside and having a structure in which the micropores are connected to each other so that gas or liquid can pass from one surface to the other surface.

It is preferable that in the polyolefin microporous membrane, the polyolefin is preferably contained in an amount of 90 parts by mass or more with respect to 100 parts by mass of the polyolefin microporous membrane, and an additive such as an organic filler, an inorganic filler, or a surfactant may be contained as the balance as long as the effects of the disclosure are not impaired.

### (Pore Diameter)

In the disclosure, the polyolefin microporous membrane has an average value of pore diameters of from 1 nm to 50 nm. An average value of pore diameters of from 1 nm to 50 nm indicates a small pore diameter. In a case in which the average value of pore diameters of the polyolefin microporous membrane is 1 nm or more, sufficient liquid permeability as a liquid filter can be obtained. From such a viewpoint, the average value of pore diameters is preferably 10 nm or more, more preferably 11 nm or more, and still more preferably 13 nm or more. In a case in which the average value of pore diameters of the polyolefin microporous membrane is 50 nm or less, fine particles of, for example, about 10 nm can be extremely highly collected. From such a viewpoint, the average value of pore diameters is preferably 40 nm or less, more preferably 30 nm or less, still more preferably 25 nm or less, and particularly preferably 20 nm or less.

In the disclosure, from the viewpoint of further suppressing the variation in filtration time, the polyolefin microporous membrane has a coefficient of variation in pore diameter of preferably 0.100 or less, more preferably 0.095 or less, still more preferably 0.093 or less, and particularly preferably 0.085 or less. The coefficient of variation in pore diameter may be 0.0015 or more, preferably 0.020 or more, and more preferably 0.024 or more. The coefficient of variation in pore diameter is preferably from 0.0015 to 0.100.

In the disclosure, the value of the pore diameter of the polyolefin microporous membrane, and the average value and the coefficient of variation thereof refer to values determined by the methods described in the section of Examples.

### (Water Flow Rate)

In the disclosure, the polyolefin microporous membrane has an average value of water flow rates of from 0.003 L/min/ft²/psi to 0.180 L/min/ft²/psi. In a case in which the average value of water flow rates of the polyolefin microporous membrane is 0.003 L/min/ft²/psi or more, not only the water permeation efficiency as a liquid filter is likely to be sufficiently obtained, but also the stability of solution feeding through the filter (for example, the stability of a power load for maintaining a constant solution feeding amount and the stability of a solution feeding amount under a constant solution feeding pressure (constant power load)) is likely to be obtained over a long period of time, which is preferable. From such a viewpoint, the average value of water flow rates of the polyolefin microporous membrane is preferably 0.004 L/min/ft²/psi or more and more preferably 0.005 L/min/ft²/psi or more. In a case in which the average value of water flow rates of the polyolefin microporous membrane is 0.180 L/min/ft²/psi or less, fine particles of, for example, about 10 nm or less are likely to be highly collected, which is preferable. From such a viewpoint, the average value of water flow rates of the polyolefin microporous membrane is preferably 0.150 L/min/ft²/psi or less and more preferably 0.100 L/min/ft²/psi or less.

In the disclosure, from the viewpoint of further suppressing the variation in filtration time, the polyolefin microporous membrane has a coefficient of variation in water flow rate of 0.100 or less, preferably 0.095 or less, more preferably 0.090 or less, and still more preferably 0.080 or less. The coefficient of variation in water flow rate may be 0.010 or more, preferably 0.015 or more, and more preferably 0.018 or more. The coefficient of variation in water flow rate is preferably from 0.010 to 0.100.

In the disclosure, the value of the water flow rate of the polyolefin microporous membrane, and the average value and the coefficient of variation thereof refer to values determined by the methods described in the section of Examples.

### (Membrane Thickness)

In the disclosure, the average value of membrane thickness of the polyolefin microporous membrane is preferably from 3 μm to 20 μm. In a case in which the average value of membrane thickness of the polyolefin microporous membrane is 3 μm or more, sufficient dynamic strength is likely to be obtained, and handleability during the processing of the polyolefin microporous membrane and the like, and durability in the long-term use of a filter cartridge are likely to be obtained. From such a viewpoint, the average value of membrane thickness of the polyolefin microporous membrane is more preferably 4 μm or more, still more preferably 5 μm or more, and particularly preferably 6 μm or more. In a case in which the average value of membrane thickness is 20 μm or less, the thickness variation in the width direction is reduced, sufficient liquid permeability can be obtained with the polyolefin microporous membrane singly, and in a filter cartridge of a predetermined size, a larger filtration area is likely to be obtained, thereby facilitating the flow rate design and structural design of the filter during the processing of the polyolefin microporous membrane. From such a viewpoint, the average value of membrane thickness of the polyolefin microporous membrane is more preferably 18 μm or less, still more preferably 16 μm or less, and particularly preferably 14 μm or less.

For example, assuming the placement of a filter cartridge in a housing of the same size, as a filter medium (the whole constituent material including the substrate for a filter) becomes thinner, a filter medium area can be made larger, so that a high-flow-rate/low-filtration-pressure design which is preferable as a liquid filter can be achieved. That is, it becomes possible to design a liquid filter such that the filtration pressure decreases in a case in which the same flow rate is to be maintained while the flow rate increases in a case in which the same filtration pressure is to be maintained. In particular, in a case in which the filtration pressure decreases, it becomes much less likely that foreign matters once collected are continuously exposed to the filtration pressure in the filter medium, thus are pushed out from the inside of the filter medium with the lapse of time together with the filtrate, and leak out. In a case in which the filtration pressure decreases, it becomes much less likely that a gas dissolved and present in the liquid to be filtered appears in the form of fine bubbles due to the pressure difference before and after filtration (pressure decrease after filtration). It becomes likely that the filtration yield of a filtration object such as a liquid chemical is improved, and the quality of a filtration object such as a liquid chemical is maintained at a high level over a long period of time

Meanwhile, as the filter medium becomes thinner, the strength and durability performance of the filter medium are lowered; however, for example, in designing a filter, it is also possible to combine the filter with a coarse high-strength support for reinforcement (for example, processing to stack the filter and the support and fold the stack) to adjust the designing of durability and flow rate.

In the disclosure, from the viewpoint of further suppressing the variation in filtration time, the polyolefin microporous membrane has a coefficient of variation in membrane thickness of preferably 0.100 or less, more preferably 0.095 or less, still more preferably 0.090 or less, and particularly preferably 0.065 or less. The coefficient of variation in membrane thickness may be 0.0015 or more, preferably 0.018 or more, and more preferably 0.020 or more. The coefficient of variation in membrane thickness is preferably from 0.0015 to 0.100.

In the disclosure, the value of the membrane thickness of the polyolefin microporous membrane, and the average value and the coefficient of variation thereof refer to values determined by the methods described in the section of Examples.

### (Porosity)

In the disclosure, the average value of porosity of the polyolefin microporous membrane is preferably from 35% to 60%. In a case in which the average value of porosity of the polyolefin microporous membrane is 35% or more, a liquid permeation efficiency becomes favorable, and from such a viewpoint, the average value of porosity is more preferably 36% or more, still more preferably 38% or more, and particularly preferably 40% or more. In a case in which the average value of porosity is 60% or less, the dynamic strength of the polyolefin microporous membrane becomes favorable, and handleability is also improved, which is preferable. From such a viewpoint, the average value of porosity of the polyolefin microporous membrane is more preferably 59% or less, still more preferably 58% or less, and particularly preferably 55% or less.

In the disclosure, from the viewpoint of further suppressing the variation in filtration time, the polyolefin microporous membrane has a coefficient of variation in porosity of preferably 0.100 or less, more preferably 0.095 or less, still more preferably 0.090 or less, and particularly preferably 0.075 or less. The coefficient of variation in porosity may be 0.020 or more, preferably 0.025 or more, and more preferably 0.026 or more. The coefficient of variation in porosity is preferably from 0.020 to 0.100.

In the disclosure, the value of the porosity of the polyolefin microporous membrane, and the average value and the coefficient of variation thereof refer to values determined by the methods described in the section of Examples.

### (Calcium Content)

In the disclosure, the calcium content in the polyolefin microporous membrane is preferably 2000 ppb or less. In a case in which the calcium content is 2000 ppb or less, washing time when a filter cartridge is produced can be significantly reduced, and furthermore, a solvent such as water used in washing can also be greatly reduced. From such a viewpoint, the calcium content of the polyolefin microporous membrane is more preferably 1500 ppb or less, still more preferably 1300 ppb or less, particularly preferably 1000 ppb or less, and extremely preferably 800 ppb or less. From the viewpoint of production efficiency of a filter cartridge, the calcium content as low as possible is preferable. However, realistically speaking, a trace amount of calcium is sometimes contained in a raw material for production or a trace amount of calcium is sometimes incorporated in a production step of the polyolefin microporous membrane, and thus it is difficult to reduce the calcium content. The calcium content of the polyolefin microporous membrane may be 0 ppb or more, 1 ppb or more, 10 ppb or more, or 50 ppb. In a case in which the calcium content is 2000 ppb or less, the production efficiency of a filter cartridge can be significantly improved.

In the disclosure, a polyolefin microporous membrane having fine pores, in which the average value of pore diameters is from 1 nm to 50 nm, is applied. In such a polyolefin microporous membrane having fine pores, a specific surface area becomes dramatically large, and metal ions to be dissolved or the like tend to increase. However, in a case in which the calcium content is 2000 ppb or less, the production efficiency of a filter cartridge can be significantly improved even in such a polyolefin microporous membrane having fine pores. In a case in which the calcium content of the polyolefin microporous membrane is 1 ppb or more, chloride ions derived from a polymerization catalyst, which would remain in the polyolefin in minute amounts, can be sufficiently neutralized, and corrosion of piping made of stainless steel or the like in a production facility of the polyolefin microporous membrane is prevented. From such a viewpoint, the calcium content of the polyolefin microporous membrane is preferably 10 ppb or more and more preferably 50 ppb or more.

In the disclosure, a method of adjusting the calcium content of the polyolefin microporous membrane to 2000 ppb or less is not particularly limited, and examples thereof include using a material having a calcium content of from 0 ppb to 1000 ppb as a polyolefin raw material constituting the polyolefin microporous membrane, and washing with an acid or the like for a long time after the polyolefin microporous membrane is produced. From the viewpoint that the calcium content can be sufficiently reduced to the inside of the polyolefin microporous membrane, polyolefin raw material having a low calcium content is preferably used.

In the disclosure, the calcium content of the polyolefin microporous membrane refers to a value determined by the method described in the section of Examples.

A method of controlling the porous structure of the polyolefin microporous membrane is not particularly limited. For example, the porous structure can be controlled by the composition of a polyolefin resin, the concentration of the polyolefin resin in a raw material, a mixing ratio of multiple solvents used in the raw material, a heating temperature for expressing a solvent from the inside of the extruded sheet, a pressing pressure, a heating time, a draw ratio, a heat treatment (heat setting) temperature after drawing, an immersion time in an extraction solvent, annealing treatment temperature and time, and the like.

### (Polyolefin)

In the disclosure, as the polyolefin constituting the polyolefin microporous membrane, for example, a homopolymer or copolymer of polyethylene, polypropylene, polybutylene, polymethylpentene, or the like, or a mixture of two or more kinds thereof can be used. Among them, polyethylene is preferable. As polyethylene, high-density polyethylene, a mixture of high-density polyethylene and ultra-high-molecular-weight polyethylene, or the like is suitable. Polyethylene may be used in combination with other components. Examples of the components other than polyethylene include polypropylene, polybutylene, polymethylpentene, and a copolymer of polypropylene and polyethylene. As polyolefin, polyolefins that are different in properties may be used in combination. Specifically, polyolefins that are different in polymerization degree or branching degree and poorly compatible with each other, in other words, polyolefins that are different in crystallinity, stretchability or molecular orientation may be used in combination.

In particular, as the polyolefin used in the disclosure, it is preferable to use a polyethylene composition obtained by mixing high-molecular-weight polyethylene having a weight average molecular weight of from 3000000 to 6000000 and low-molecular-weight polyethylene having a weight average molecular weight of from 200000 to 800000. Blending of suitable amounts of two or more kinds of polyethylenes is effective in, during drawing, forming a network web structure associated with fibrillation and increasing the occurrence of pores.

In particular, the blending ratio of the high-molecular-weight polyethylene and the low-molecular-weight polyethylene is preferably from 15:85 to 85:15 and more preferably from 19:81 to 81:19 by mass ratio.

As the low-molecular-weight polyethylene, high-density polyethylene having a density of from 0.92 g/cm³ to 0.98 g/cm³ is preferable.

The weight average molecular weight is determined by dissolving a polyolefin microporous membrane sample in o-dichlorobenzene by heating, and performing measurement under conditions of a column temperature of 135 °C and a flow velocity of 1.0 mL/min using GPC (Alliance GPC 2000 manufactured by Waters Corporation, columns; GMH6-HT and GMH6-HTL). Monodisperse polystyrene (manufactured by Tosoh Corporation) can be used for calibrating the molecular weight.

In the disclosure, the polyolefin constituting the polyolefin microporous membrane has a calcium content of preferably 0 ppb or more, more preferably 50 ppb or more, and still more preferably 100 ppb or more. The polyolefin constituting the polyolefin microporous membrane has a calcium content of preferably 1000 ppb or less, more preferably 500 ppb or less, and still more preferably 300 ppb or less.

Examples of a method of adjusting the calcium content to 1000 ppb or less include a method of adjusting the amount of metallic soap (calcium stearate or the like) to be added to the polyolefin after polymerization. Examples thereof also include an adjusting method by acid washing of a commercial polyolefin raw material.

In the disclosure, the calcium content of the polyolefin refers to a value determined by the method described in the section of Examples.

### <Liquid Filter>

The substrate for a liquid filter of the disclosure described above is, after processing to impart compatibility with a liquid chemical if appropriate, processed into a cartridge form, which can be used as a liquid filter. The liquid filter is an instrument for removing particles including at least one of an organic substance or an inorganic substance from a liquid to be treated which contains or may contain the particles. The particles are present in the form of a solid or a gel in the liquid to be treated. The liquid filter of the disclosure suitable for removing extremely fine particles having a particle size of about several nm. The liquid filter can also be used in not only a semiconductor production step but also other production steps such as display production and polishing.

As a substrate for a liquid filter, for example, a porous substrate made of polytetrafluoroethylene and the like is well known. In a case in which a substrate including the polyolefin microporous membrane of the disclosure described above is used as the substrate for a liquid filter, the substrate has higher compatibility with a liquid chemical than that of a polytetrafluoroethylene porous substrate. Therefore, for example, effects that facilitating the processing to impart compatibility with the liquid chemical to the filter is facilitated, and in a case in which a filter cartridge is placed in a filter housing to start filtration of the liquid chemical and the filter is filled with a liquid chemical, an air pocket is less likely to be formed in the filter cartridge, resulting in improved yield of liquid chemical filtration, are exhibited. Since a polyethylene structure itself does not contain a halogen element, the used filter cartridge is easy to be handled, which is effective in reducing the environmental load, for example.

### <Method of Producing Polyolefin Microporous Membrane and Method of Controlling Pore Structure>

The polyolefin microporous membrane included in the substrate for a liquid filter of the disclosure can be preferably produced by the following method. That is, the polyolefin microporous membrane can be preferably produced by sequentially performing the following steps:
(I) a step of preparing a solution containing a polyolefin composition and a solvent,
(II) a step of melt-kneading the prepared solution, extruding the obtained melt-kneaded product from a die, and cooling and solidifying the melt-kneaded product to obtain a gel-like molded product,
(III) a step of previously expressing a part of the solvent from the gel-like molded product,
(IV) a step of drawing the gel-like molded product, from which a part of the solvent has been expressed, in at least one direction, and
(V) a step of extracting and washing the solvent from the inside of the drawn intermediate molded product.

In the step (I), a solution containing a polyolefin composition and a solvent is prepared. The solvent is preferably at least a volatile solvent having a boiling point of less than 210 °C at atmospheric pressure. The solution is preferably a thermally reversible sol-gel solution. In the step (I), specifically, the polyolefin composition is dissolved by heating in the solvent to form a sol, thereby preparing a thermally reversible sol-gel solution. The volatile solvent having a boiling point of less than 210 °C at atmospheric pressure is not particularly limited as long as it can swell or dissolve the polyolefin, and preferred examples thereof include liquid solvents such as tetralin, ethylene glycol, decalin, toluene, xylene, diethyltriamine, ethylenediamine, dimethyl sulfoxide, and hexane. These may be used singly, or in combination of two or more kinds thereof. Among them, decalin or xylene is preferable. In the preparation of the solution, in addition to the volatile solvent having a boiling point of less than 210 °C at atmospheric pressure described above, it is also possible to add a non-volatile solvent having a boiling point of 210 °C or more, such as liquid paraffin, paraffin oil, mineral oil, or castor oil.

In the solution of the step (I), from the viewpoint of controlling the liquid permeation performance of the polyolefin microporous membrane and the removal performance as a filter medium, the concentration of the polyolefin composition is preferably from 15% by mass to 40% by mass and more preferably from 20% by mass to 30% by mass. In a case in which the concentration of the polyolefin composition is 15% by mass or more, the dynamic strength tends not to become too low, thereby favorably maintaining handleability, and furthermore, occurrence frequency of breakage in the formation of the polyolefin microporous membrane tends to be suppressed. In a case in which the concentration of the polyolefin composition is 40% by mass or less, pores tend to be easily formed.

In the step (II), the solution prepared in the step (I) is melt-kneaded, and the obtained melt-kneaded product is extruded from a die and then cooled and solidified to obtain a gel-like molded product. It is preferable that extrusion from a die is performed at a temperature within a range of from the melting point of the polyolefin composition to a temperature higher than the melting point by 65 °C to obtain an extruded product, and then the extruded product is cooled to obtain a gel-like molded product. It is preferable that the molded product is formed into a sheet shape.

A method of cooling the extruded product is not particularly limited, and a method based on quenching with water or an organic solvent and a method based on casting on a cooled metal roll may be used. Generally, a method based on quenching with water or the volatile solvent used for the sol-gel solution is used. The cooling temperature is preferably from 10 °C to 40 °C. It is preferable that a water flow is provided on the surface layer of a water bath, and a gel-like sheet is produced while preventing the mixed solvent released from a gelled sheet in the water bath and floating on the water surface from re-adhering to the sheet.

The step (III) is a step of, before drawing the gel-like molded product in at least one direction, previously expressing a part of the solvent in the gel-like molded product. The step (III) can be suitably performed by, for example, applying a pressure to the surface of the gel-like molded product by a method in which the product is passed through a gap between upper and lower two belts or rollers, and the like. The amount of the solvent to be expressed has to be adjusted according to the required liquid permeation performance and filtration object removal performance of the polyolefin microporous membrane. Specifically, the adjustment can be made within an appropriate range with the pressing pressure between the upper and lower belts or rollers, the temperature in the expression step, and the number of presses. The pressure that the gel-like molded product receives is preferably set to be within a range of from 0.01 MPa to 0.5 MPa using a roller or the like. The pressure is still more preferably within a range of from 0.05 MPa to 0.2 MPa. The expression temperature is preferably from 40 °C to 100 °C. The number of presses depends on the space allowance in the facility, and thus pressing can be set without particular limitation. If necessary, single-stage or multistage preheating may be performed before solvent expression to remove a part of the volatile solvent from the inside of the sheet. In this case, the preheating temperature is preferably from 50 °C to 100 °C. The preheating is preferably performed for from 5 to 9 minutes per stage. In this case, the amount of the volatile solvent to be removed is adjusted by a conveying distance and a conveying speed in a heating device.

The step (IV) is a step of drawing the gel-like molded product in at least one direction. Drawing in the step (IV) is preferably biaxial drawing, and either of sequential biaxial drawing, in which longitudinal drawing and lateral drawing are separately performed, or simultaneous biaxial drawing, in which longitudinal drawing and lateral drawing are simultaneously performed, can be suitably used. A method in which the product is drawn in the longitudinal direction several times and then drawn in the lateral direction, a method in which the product is drawn in the longitudinal direction and drawn in the lateral direction several times, and a method in which the product is sequentially biaxially drawn and then further drawn in the longitudinal direction and/or in the lateral direction once or several times are also preferable.

From the viewpoint of controlling the liquid permeation performance and filtration object removal performance of the polyolefin microporous membrane, the draw ratio (the product of the longitudinal draw ratio and the lateral draw ratio) is preferably from 40 times to 105 times, and more preferably from 50 times to 100 times. In a case in which the draw ratio is 40 times or more, occurrence of thickness unevenness of the polyolefin microporous membrane tends to be easily suppressed. In a case in which the draw ratio is 105 times or less, occurrence frequency of breakage in the formation of the polyolefin microporous membrane tends to decrease. Drawing is preferably performed with the solvent remaining in a suitable state. The drawing temperature is preferably from 80 °C to 125 °C. The drawing temperature is particularly preferably from 100 °C to 120 °C.

After drawing in the step (IV), heat setting treatment may be performed.

From the viewpoint of controlling the liquid permeation performance and filtration object removal performance of the polyolefin microporous membrane, the heat setting temperature is preferably from 100 °C to 143 °C. The heat setting temperature is still more preferably from 105 °C to 138 °C. In a case in which the heat setting temperature is 100 °C or higher, the liquid permeation performance of the polyolefin microporous membrane tends to be further improved. In a case in which the heat setting temperature is 143 °C or lower, the filtration object removal performance of the polyolefin microporous membrane tends to be further improved.

The step (V) is a step of, in order to extract the solvent from the inside of the drawn intermediate molded product, washing the drawn intermediate molded product. In the step (V), in order to extract the solvent from the inside of the drawn intermediate molded product (drawn film), washing is preferably performed with a halogenated hydrocarbon solvent such as methylene chloride or a hydrocarbon solvent such as hexane. In a case in which washing is performed by immersing the intermediate molded product in a tank filled with a solvent, in order to obtain a polyolefin microporous membrane with low dissolution, washing is preferably performed for from 20 seconds to 150 seconds, more preferably from 25 seconds to 150 seconds, and particularly preferably from 30 seconds to 120 seconds. In order to further improve the effect of washing, it is preferable that the tank is divided into several stages, and the washing solvent is poured from the downstream side of the conveying step of the polyolefin microporous membrane for making the washing solvent flow toward the upstream side of the conveying step so that the purity of the washing solvent in a downstream tank is higher than that in an upstream tank. In a case in which the tank storing the solvent is divided into several stages, the number of stages may be two or three or more. From the viewpoint of making the gradient of the purity of the washing solvent in each tank gentler, the number of tanks storing the solvent is preferably three or more.

Depending on the performance requirements for the polyolefin microporous membrane, heat setting may be performed by annealing treatment (heating treatment). From the viewpoint of conveying properties in the step or the like, the annealing treatment is preferably performed at from 50 °C to 150 °C, and still more preferably performed at from 60 °C to 140 °C. From the viewpoint of suppressing shrinkage of the polyolefin microporous membrane over time, the annealing treatment is preferably performed at from 100 °C to 130 °C.

In a case in which the annealing treatment is performed, it is preferable to suppress shrinkage in the width direction of the polyolefin microporous membrane. By suppressing shrinkage in the width direction, the coefficient of variation in water flow rate or the like of the polyolefin microporous membrane tends to decrease. For example, in a case in which the annealing treatment is performed in a state where both ends in the width direction of the polyolefin microporous membrane are fixed with clips or the like, shrinkage of the polyolefin microporous membrane in the width direction tends to be suppressed.

The pore diameter, membrane thickness, porosity, and water flow rate of the polyolefin microporous membrane can be within predetermined ranges by appropriately adjusting the blending of the polyolefin, the concentration of the polyolefin composition in the polyolefin solution, the method of preparing the base tape, the method of removing the solvent in the polyolefin solution, the drawing conditions and heat treatment conditions of the base tape, and the like.

### EXAMPLES

Hereinafter, Examples, Comparative Examples, and various measurement methods of the disclosure will be described; however, the disclosure is not limited to these Examples.

### [Measurement Methods]

### (Membrane Thickness)

The membrane thickness of the polyolefin microporous membrane was measured by a contact thickness gauge (manufactured by Mitutoyo Corporation). As a contact terminal, a terminal having a cylindrical shape with a bottom face having a diameter of 0.5 cm was used. The measurement pressure was 0.1 N.

### —Average Value—

The membrane thickness were measured as described above at 11 points in total, that is, at the center of the product width and at 5 points with an interval of 26 mm from the center toward each end face along the width direction (TD direction) of the polyolefin microporous membrane, and the value calculated as the arithmetic average of the membrane thickness at each measurement point was taken as the average value of the membrane thickness.

### —Coefficient of Variation—

The membrane thickness were measured as described above at 11 points in total, that is, at the center of the product width and at 5 points with an interval of 26 mm from the center toward each end face along the width direction (TD direction) of the polyolefin microporous membrane, and a standard deviation σTD1 was determined based on the value of the membrane thickness at each measurement point. Next, a coefficient of variation CVTD1 was determined by dividing σTD1 by the average value of the membrane thickness at 11 points in total. The same operation was further repeated 9 times every 50 mm along the longitudinal direction of the polyolefin microporous membrane to calculate coefficients of variation CVTD1 to CVTD10 for 10 times in total. The arithmetic average of the obtained coefficients of variation CVTD1 to CVTD10 was taken as the coefficient of variation of the membrane thickness.

### (Porosity)

The porosity (8) of the polyolefin microporous membrane was calculated by the following formula.

ε(%)={1−Ws/(ds·t)}×100
Ws: Weight per unit area of polyolefin microporous membrane (g/m²)
ds: True density of polyolefin (g/cm³)
t: Membrane thickness of polyolefin microporous membrane (μm)

The weight per unit area of the polyolefin microporous membrane was determined by cutting out a sample of 2 cm×2 cm, measuring the mass thereof, and dividing the mass by the area.

### —Average Value—

A sample of 2 cm×2 cm was cut at 7 points in total, that is, at the center of the product width and at 3 points with an interval of 20 mm from the center toward each end face along the width direction (TD direction) of the polyolefin microporous membrane, and the porosity of each of the samples was measured as described above. The value calculated as the arithmetic average for each measurement sample was taken as the average value of the porosity.

### —Coefficient of Variation—

The porosity was measured as described above at 7 points in total, that is, at the center of the product width and at 3 points with an interval of 20 mm from the center toward each end face along the width direction (TD direction) of the polyolefin microporous membrane, and a standard deviation σTD1 was determined based on the value of the porosity at each measurement point. Next, a coefficient of variation CVTD1 was determined by dividing σTD1 by the average value of the porosity at 7 points in total. The same operation was further repeated 9 times every 50 mm along the longitudinal direction of the polyolefin microporous membrane to calculate coefficients of variation CVTD1 to CVTD10 for 10 times in total. The arithmetic average of the obtained coefficients of variation CVTD1 to CVTD10 was taken as the coefficient of variation of the porosity.

### (Pore Diameter)

The average flow pore diameter measured by the following method was taken as the pore diameter of the polyolefin microporous membrane.

The average flow pore diameter of the polyolefin microporous membrane according to gas-liquid phase substitution was measured by a pore size distribution measurement test method [half dry method (ASTM E1294-89)] using a Perm Porometer porous material automatic micropore size distribution measurement system [Capillary Flow Porometer] manufactured by PMI Co., Ltd. A fluorinated inert liquid (trade name: Fluorinert) was used as a test solution (interfacial tension value: 16.0 dyne/cm), the measurement temperature was 25 °C, the measurement pressure was within a range of from 0 psi to 500 psi, and the measurement was performed under the following conditions.
Bubble point parameter: BUBLFLOW=50, F/PT=100, MINBPPRES=0, ZEROTIME=1 PULSEDELAY=2
Wet parameter: V2INCR=15, PREGINC=0.9, MINEQTIME=30, PRESSLEW=30, FLOWSLEW=30, EQITER=50, AVEITER=10, MAXPDIF=1, MAXFDIF=30
Dry parameter: V2INCR=40, PREGINC=2.4, MINEQTIME=30, PRESSLEW=30, FLOWSLEW=30, EQITER=40, AVEITER=10, MAXPDIF=1, MAXFDIF=30

### —Average Value—

The pore diameters were measured as described above at 5 points in total, that is, at the center of the product width and at 2 points with an interval of 50 mm from the center toward each end face along the width direction (TD direction) of the polyolefin microporous membrane, and the value calculated as the arithmetic average of the pore diameters at each measurement point was taken as the average value of the pore diameters.

### —Coefficient of Variation—

The pore diameters were measured as described above at 5 points in total, that is, at the center of the product width and at 2 points with an interval of 50 mm from the center toward each end face along the width direction (TD direction) of the polyolefin microporous membrane, and a standard deviation σTD1 was determined based on the value of the pore diameter at each measurement point. Next, a coefficient of variation CVTD1 was determined by dividing σTD1 by the average value of the pore diameters at 5 points in total. The same operation was further repeated 9 times every 50 mm along the longitudinal direction of the polyolefin microporous membrane to calculate coefficients of variation CVTD1 to CVTD10 for 10 times in total. The arithmetic average of the obtained coefficients of variation CVTD1 to CVTD10 was taken as the coefficient of variation of the pore diameter.

### (Water Flow Rate)

The polyolefin microporous membrane was immersed in ethanol and dried at room temperature (24 °C). The polyolefin microporous membrane was cut into 40 mm square, and set in a stainless steel liquid permeation cell (liquid permeation area S: 10.75 cm²) having a diameter of 37 mm. The polyolefin microporous membrane on the liquid permeation cell was wetted with a small amount (0.5 ml) of ethanol, pre-weighed pure water V (100 ml) was then passed therethrough at a pressure differential of 90 kPa, and the time Tl (min) taken for the entire amount of pure water to pass was measured. From the amount of pure water and the time taken for the passing of pure water, the water permeation volume Vs (L/min/ft²/psi) per unit time (min) and unit area (ft²) at a pressure differential of 1 psi was calculated by the following formula. The measurement was performed under a temperature atmosphere at room temperature of 24 °C.

Vs=(V/1000)/Tl/(S/929.03)/(90/6.895)

### —Average Value—

A sample was cut into 40 mm square at 5 points in total, that is, at the center of the product width and at 2 points with an interval of 15 mm from the center toward each end face along the width direction (TD direction) of the polyolefin microporous membrane, and the water flow rate of each of the samples was measured as described above. The value calculated as the arithmetic average for each measurement sample was taken as the average value of the water flow rates.

### —Coefficient of Variation—

The water flow rates were measured as described above at 5 points in total, that is, at the center of the product width and at 2 points with an interval of 15 mm from the center toward each end face along the width direction (TD direction) of the polyolefin microporous membrane, and a standard deviation σVs1 was determined based on the value of the water flow rate at each measurement point. Next, a coefficient of variation CVVs1 was determined by dividing σVs1 by the average value of the water flow rates at 5 points in total. The same operation was further repeated 9 times every 50 mm along the longitudinal direction of the polyolefin microporous membrane to calculate coefficients of variation CVVs1 to CVVs10 for 10 times in total. The arithmetic average of the obtained coefficients of variation CVVs1 to CVVs10 was taken as the coefficient of variation of the water flow rate.

### (Variation in Filtration Time)

As a test liquid as a filtration fluid, an aqueous solution containing a metallic colloid (gold colloid) having an average particle diameter of 5 nm manufactured by Funakoshi Co., Ltd. at a particle concentration of 40 ppb was prepared and used.

In order to evaluate the filtration life, the polyolefin microporous membrane was cut out along the TD direction of the polyolefin microporous membrane into 5 cm square from three points of the center and both end faces of the product width. The cut polyolefin microporous membrane was set in a stainless steel liquid permeation cell (liquid permeation area S: 10.75 cm²) having a diameter of 37 mm. The polyolefin microporous membrane on the liquid permeation cell was wetted with a small amount (0.5 ml) of ethanol, 200 ml of the test liquid was then subjected to liquid filtration at a differential pressure of 0.1 MPa, and the time TF taken for the entire amount of the test liquid to pass was measured. In a case in which the value of the shortest filtration time was defined as TF=1, a case in which the ratio of the value of the longest filtration time was 1.2 or less was evaluated as A, and a case in which the ratio exceeded 1.3 was evaluated as B.

### (Collection Efficiency)

The collection rate of particles was determined by the following formula from the metallic colloid concentration of the test liquid before the measurement of the filtration time (M1) and the metallic colloid concentration of the filtrate that passed through the polyolefin microporous membrane used in the measurement of the filtration time (M2). The arithmetic average value of collection rates measured at three points of the center portion and both end faces of the product width along the TD direction of the polyolefin microporous membrane and taken as the collection rate of the polyolefin microporous membrane. The metallic concentration of the solution was determined with a calibration curve obtained by diluting a standard reagent using ICP-OES (Inductively Coupled Plasma Optical Emission Spectrometry, device name: Agilent-ICP-OES-5100, Agilent Technologies, Inc.), and taking 5 points or more in a concentration range of from 0 ppb to 100 ppb. The collection efficiency was evaluated according to the following criteria.

Collection rate (%)=((M1−M2)/(M1))×100

### —Evaluation Criteria—

A: A case in which the collection rate is 80% or more
B: A case in which the collection rate is from 60% to less than 80%
C: A case in which the collection rate is from 30% to less than 60%

### (Calcium (Ca) Content)

In a fluororesin container, 0.1 g of a measurement sample was accurately weighed, ultrapure nitric acid was added to perform microwave decomposition, and the calcium content was quantitated by the order of ppb using ICP (Inductively Coupled Plasma) mass spectrometry (ICP-MS, device name: Agilent7500cs, Agilent Technologies, Inc.).

(Amount of Dissolution of Calcium (Ca) from Porous Membrane)

A 4000 cm² polyolefin microporous membrane sample from which dust on the surface was removed was placed in a fluororesin container, and 200 g of a 10% by mass hydrochloric acid extract containing 60% by mass of isopropyl alcohol was poured. The sample was immersed in the container for 24 hours, and then the Ca concentration in the liquid was quantified to the order of 0.1 ppb by ICP-OES (Inductively Coupled Plasma Optical Emission Spectrometry, device name: Agilent-ICP-OES-5100, Agilent Technologies, Inc.). The amount of dissolution of Ca from the polyolefin microporous membrane was calculated from the extract mass, the surface area of the polyolefin microporous membrane, and the value of the Ca concentration in the extract, and was determined in unit of μg/m².

### (Method of Producing Polyolefin Microporous Membrane)

Hereinafter, details of the method of producing a polyolefin microporous membrane in each of Examples and Comparative Examples will be described.

The main differences in production method between Examples and Comparative Examples are in that a methylene chloride bath is used in three tanks in Examples, whereas a methylene chloride bath is used in two tanks in Comparative Examples and in that in the case of performing heating treatment, the width is fixed in the TD direction in Examples, whereas the width is not fixed in Comparative Examples.

### Example 1

A polyethylene composition obtained by mixing 22 parts by mass of ultra-high-molecular-weight polyethylene having a weight average molecular weight of 4600000 and a Ca content of 140 ppb and 5 parts by mass of high-density polyethylene having a weight average molecular weight of 500000 and a Ca content of 230 ppb was used. A pre-prepared mixed solvent of 72 parts by mass of liquid paraffin and 1 part by mass of decalin (decahydronaphthalene) was mixed with the polyethylene composition such that the total polyethylene resin concentration was 27% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a gel-like sheet (base tape) was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 5 times (longitudinal drawing) and successively drawn in the width direction at a temperature of 112 °C to 15 times (lateral drawing), and then heat treatment (heat setting) was performed at a temperature of 115 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 110 °C for 1 minute while the width was fixed to be constant with respect to the TD direction, and cooling was performed at 60 °C for 20 seconds to obtain a substrate for a liquid filter including a polyolefin microporous membrane.

The physical properties of the obtained substrate for a liquid filter are shown in Table 1. The physical properties of the following Examples and Comparative Examples are similarly shown in Table 1 or Table 2.

### Example 2

A substrate for a liquid filter including a polyolefin microporous membrane was obtained in the same manner as in Example 1, except that the longitudinal draw ratio was set to 6 times.

### Example 3

A substrate for a liquid filter including a polyolefin microporous membrane was obtained in the same manner as in Example 1, except that the longitudinal draw ratio was set to 6.5 times and the lateral draw ratio was set to 13.8 times.

### Example 4

A polyethylene composition obtained by mixing 21 parts by mass of ultra-high-molecular-weight polyethylene having a weight average molecular weight of 4600000 and a Ca content of 110 ppb and 5 parts by mass of high-density polyethylene having a weight average molecular weight of 500000 and a Ca content of 230 ppb was used. A pre-prepared mixed solvent of 73 parts by mass of liquid paraffin and 1 part by mass of decalin was mixed with the polyethylene composition such that the total polyethylene resin concentration was 26% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 5 times (longitudinal drawing) and successively drawn in the width direction at a temperature of 115 °C to 15 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 5

A polyethylene composition obtained by mixing 18 parts by mass of ultra-high-molecular-weight polyethylene having a weight average molecular weight of 4600000 and a Ca content of 140 ppb and 5 parts by mass of high-density polyethylene having a weight average molecular weight of 500000 and a Ca content of 230 ppb was used. A pre-prepared mixed solvent of 76 parts by mass of liquid paraffin and 1 part by mass of decalin was mixed with the polyethylene composition such that the total polyethylene resin concentration was 23% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 4 times (longitudinal drawing) and successively drawn in the width direction at a temperature of 115 °C to 15 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 6

A polyethylene composition obtained by mixing 3 parts by mass of ultra-high-molecular-weight polyethylene having a weight average molecular weight of 4200000 and a Ca content of 31 ppm and 14 parts by mass of high-density polyethylene having a weight average molecular weight of 400000 and a Ca content of 34 ppm was used. A pre-prepared mixed solvent of 51 parts by mass of liquid paraffin and 32 parts by mass of decalin was mixed with the polyethylene composition such that the total polyethylene resin concentration was 17% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C. while a pressure of 0.05 MPa was applied to the base tape to remove a part of liquid paraffin from the inside of the base tape. Thereafter, the base tape was drawn in the longitudinal direction at a temperature of 100 °C to 4.5 times (longitudinal drawing) and successively drawn in the width direction at a temperature of 115 °C to 8 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 7

A polyethylene composition obtained by mixing 12 parts by mass of ultra-high-molecular-weight polyethylene having a weight average molecular weight of 4200000 and a Ca content of 31 ppm and 5 parts by mass of high-density polyethylene having a weight average molecular weight of 400000 and a Ca content of 34 ppm was used. A pre-prepared mixed solvent of 51 parts by mass of liquid paraffin and 32 parts by mass of decalin was mixed with the polyethylene composition such that the total polyethylene resin concentration was 17% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 4 times (longitudinal drawing) and successively drawn in the width direction at a temperature of 115 °C to 9 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 8

A polyethylene composition obtained by mixing 6 parts by mass of ultra-high-molecular-weight polyethylene having a weight average molecular weight of 4200000 and a Ca content of 31 ppm and 24 parts by mass of high-density polyethylene having a weight average molecular weight of 400000 and a Ca content of 34 ppm was used. A pre-prepared mixed solvent of 68 parts by mass of liquid paraffin and 2 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 95 °C to 4 times (longitudinal drawing) and successively drawn in the width direction at a temperature of 110 °C to 11 times (lateral drawing), and then heat treatment (heat setting) was performed at a temperature of 120 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 9

A polyethylene composition obtained by mixing 15 parts by mass of ultra-high-molecular-weight polyethylene having a weight average molecular weight of 4200000 and a Ca content of 31 ppm and 15 parts by mass of high-density polyethylene having a weight average molecular weight of 400000 and a Ca content of 34 ppm was used. A pre-prepared mixed solvent of 68 parts by mass of liquid paraffin and 2 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 4 times (longitudinal drawing) and successively drawn in the width direction at a temperature of 115 °C to 10 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Example 10

A polyethylene composition obtained by mixing 17 parts by mass of ultra-high-molecular-weight polyethylene having a weight average molecular weight of 4200000 and a Ca content of 31 ppm and 4 parts by mass of high-density polyethylene having a weight average molecular weight of 400000 and a Ca content of 34 ppm was used. A pre-prepared mixed solvent of 78 parts by mass of liquid paraffin and 1 part by mass of decalin was mixed with the polyethylene composition such that the total polyethylene resin concentration was 21% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 4 times (longitudinal drawing) and successively drawn in the width direction at a temperature of 115 °C to 8 times (lateral drawing), and then heat treatment (heat setting) was performed at a temperature of 125 °C.

Next, the heat-treated base tape was immersed in a three-tank methylene chloride bath successively for 30 seconds per tank, thereby extracting liquid paraffin. In a case in which the tank where immersion is started is defined as a first tank, and the tank where immersion is finished is defined as a third tank, the purity of the washing solvent is (low) first tank<second tank<third tank (high). Thereafter, methylene chloride was removed by drying at 40 °C, the base tape was subject to heating treatment in the TD direction at 120 °C for 1 minute while the width was fixed to be constant with respect to the TD direction, and cooling was performed at 60 °C for 20 seconds to obtain a substrate for a liquid filter including a polyolefin microporous membrane.

### Comparative Example 1

A polyethylene composition obtained by mixing 22 parts by mass of ultra-high-molecular-weight polyethylene having a weight average molecular weight of 4600000 and a Ca content of 140 ppb and 5 parts by mass of high-density polyethylene having a weight average molecular weight of 500000 and a Ca content of 230 ppb was used. A pre-prepared mixed solvent of 72 parts by mass of liquid paraffin and 1 part by mass of decalin was mixed with the polyethylene composition such that the total polyethylene resin concentration was 27% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 8 times (longitudinal drawing) and successively drawn in the width direction at a temperature of 112 °C to 10 times (lateral drawing), and then heat treatment (heat setting) was performed at a temperature of 115 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 110 °C, to obtain a substrate for a liquid filter including a polyolefin microporous membrane.

### Comparative Example 2

A substrate for a liquid filter including a polyolefin microporous membrane was produced in the same manner as in Comparative Example 1, except that the longitudinal draw ratio was set to 9 times.

### Comparative Example 3

A substrate for a liquid filter including a polyolefin microporous membrane was produced in the same manner as in Comparative Example 1, except that the longitudinal draw ratio was set to 10 times and the lateral draw ratio was set to 8 times.

### Comparative Example 4

A polyethylene composition obtained by mixing 3 parts by mass of ultra-high-molecular-weight polyethylene having a weight average molecular weight of 4200000 and a Ca content of 31 ppm and 14 parts by mass of high-density polyethylene having a weight average molecular weight of 400000 and a Ca content of 34 ppm was used. A pre-prepared mixed solvent of 51 parts by mass of liquid paraffin and 32 parts by mass of decalin was mixed with the polyethylene composition such that the total polyethylene resin concentration was 17% by mass, thereby preparing a polyethylene solution.

The polyethylene solution was extruded from a die into a sheet shape at a temperature of 190 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 100 °C to 6 times (longitudinal drawing) and successively drawn in the width direction at a temperature of 115 °C to 6 times (lateral drawing), and then heat treatment (heat setting) was performed at a temperature of 125 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 5

A polyethylene composition obtained by mixing 5 parts by mass of ultra-high-molecular-weight polyethylene having a weight average molecular weight of 4600000 and a Ca content of 30 ppm and 23 parts by mass of high-density polyethylene having a weight average molecular weight of 560000 and a Ca content of 36 ppm was used. A pre-prepared mixed solvent of 69 parts by mass of liquid paraffin and 3 parts by mass of decalin was mixed with the polyethylene composition such that the total polyethylene resin concentration was 28% by mass, thereby preparing a polyethylene solution.

The polyethylene solution was extruded from a die into a sheet shape at a temperature of 160 °C to obtain an extruded product, the extruded product was cooled in a water bath at 25 °C, a water flow was provided on the surface layer of the water bath, and a base tape was produced while preventing the mixed solvent released from a gelled sheet in the water bath and floating on the water surface from re-adhering to the sheet. The base tape was dried at 55 °C for 10 minutes, and then at 95 °C for 10 minutes to remove decalin from the inside of the base tape, and subsequently, the base tape was conveyed on a roller heated to 85 °C while a pressure of 20 kgf/m (1.96 MPa) was applied to the base tape to remove a part of liquid paraffin from the inside of the base tape. Thereafter, the base tape was drawn in the longitudinal direction at a temperature of 100 °C to 5.8 times (longitudinal drawing) and successively drawn in the width direction at a temperature of 100 °C to 14 times (lateral drawing), and then heat treatment (heat setting) was performed at a temperature of 118 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 45 °C, the base tape was subject to heating treatment while being conveyed on a roller heated to 110 °C, to obtain a substrate for a liquid filter including a polyolefin microporous membrane.

### Comparative Example 6

A substrate for a liquid filter including a polyolefin microporous membrane was obtained in the same manner, except that in Comparative Example 5, the base tape was conveyed on a roller heated to 40 °C while a pressure of 40 kgf/m (3.92 MPa) was applied to the base tape to remove a part of liquid paraffin from the inside of the base tape, the base tape was then drawn in the longitudinal direction at a temperature of 90 °C to 5.8 times (longitudinal drawing) and successively drawn in the width direction at a temperature of 90 °C to 14 times (lateral drawing), and then heat treatment (heat setting) was performed at a temperature of 124 °C.

### Comparative Example 7

A substrate for a liquid filter including a polyolefin microporous membrane was obtained in the same manner, except that in Comparative Example 5, the base tape was conveyed on a roller heated to 95 °C while a pressure of 5 kgf/m (0.49 MPa) was applied to the base tape to remove a part of liquid paraffin from the inside of the base tape, the base tape was then drawn in the longitudinal direction at a temperature of 95 °C to 6.5 times (longitudinal drawing) and successively drawn in the width direction at a temperature of 95 °C to 13 times (lateral drawing), and then heat treatment (heat setting) was performed at a temperature of 114 °C.

### Comparative Example 8

A substrate for a liquid filter including a polyolefin microporous membrane was obtained in the same manner, except that in Comparative Example 5, a polyethylene composition obtained by mixing 4 parts by mass of ultra-high-molecular-weight polyethylene having a weight average molecular weight of 4600000 and a Ca content of 30 ppm and 31 parts by mass of high-density polyethylene having a weight average molecular weight of 560000 and a Ca content of 36 ppm was used, and a pre-prepared mixed solvent of 55 parts by mass of liquid paraffin and 10 parts by mass of decalin was mixed with the polyethylene composition such that the total polyethylene resin concentration was 35% by mass, thereby preparing a polyethylene solution, the base tape from which a part of liquid paraffin was removed was drawn in the longitudinal direction at a temperature of 100 °C to 5 times (longitudinal drawing) and successively drawn in the width direction at a temperature of 100 °C to 9 times (lateral drawing), and then heat treatment (heat setting) was performed at a temperature of 114 °C.

### Comparative Example 9

A substrate for a liquid filter including a polyolefin microporous membrane was obtained in the same manner, except that in Comparative Example 5, a polyethylene composition obtained by mixing 8 parts by mass of ultra-high-molecular-weight polyethylene having a weight average molecular weight of 4600000 and a Ca content of 30 ppm and 24 parts by mass of high-density polyethylene having a weight average molecular weight of 560000 and a Ca content of 36 ppm was used, and a pre-prepared mixed solvent of 53 parts by mass of liquid paraffin and 15 parts by mass of decalin was mixed with the polyethylene composition such that the total polyethylene resin concentration was 32% by mass, thereby preparing a polyethylene solution, and the base tape from which a part of liquid paraffin was removed was drawn in the longitudinal direction at a temperature of 100 °C to 4 times (longitudinal drawing) and successively drawn in the width direction at a temperature of 100 °C to 15 times (lateral drawing).

### Comparative Example 10

A polyethylene composition obtained by mixing 14 parts by mass of ultra-high-molecular-weight polyethylene having a weight average molecular weight of 4600000 and a Ca content of 30 ppm and 6 parts by mass of high-density polyethylene having a weight average molecular weight of 560000 and a Ca content of 36 ppm was used. A pre-prepared mixed solvent of 55 parts by mass of liquid paraffin and 25 parts by mass of decalin was mixed with the polyethylene composition such that the total polyethylene resin concentration was 20% by mass, thereby preparing a polyethylene solution.

The polyethylene solution was extruded from a die into a sheet shape at a temperature of 160 °C to obtain an extruded product, the extruded product was cooled in a water bath at 25 °C, a water flow was provided on the surface layer of the water bath, and a base tape was produced while preventing the mixed solvent released from a gelled sheet in the water bath and floating on the water surface from re-adhering to the sheet. The base tape was dried at 55 °C for 10 minutes, and then at 95 °C for 10 minutes to remove decalin from the inside of the base tape, and subsequently, the base tape was conveyed on a roller heated to 85 °C while a pressure of 20 kgf/m (1.96 MPa) was applied to the base tape to remove a part of liquid paraffin from the inside of the base tape. Thereafter, the base tape was drawn in the longitudinal direction at a temperature of 100 °C to 5 times (longitudinal drawing) and successively drawn in the width direction at a temperature of 100 °C to 14 times (lateral drawing), and then heat treatment (heat setting) was performed at a temperature of 128 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 45 °C, the base tape was subject to heating treatment while being conveyed on a roller heated to 110 °C, to obtain a substrate for a liquid filter including a polyolefin microporous membrane.

### Comparative Example 11

A substrate for a liquid filter including a polyolefin microporous membrane was obtained in the same manner, except that in Comparative Example 10, a polyethylene composition obtained by mixing 12 parts by mass of ultra-high-molecular-weight polyethylene having a weight average molecular weight of 4600000 and a Ca content of 30 ppm and 8 parts by mass of high-density polyethylene having a weight average molecular weight of 560000 and a Ca content of 36 ppm was used.

### Comparative Example 12

A substrate for a liquid filter including a polyolefin microporous membrane was obtained in the same manner, except that in Comparative Example 10, the heat treatment (heat setting) temperature after biaxial drawing was set to 134 °C.

### Comparative Example 13

In Comparative Example 10, a polyethylene composition obtained by mixing 20 parts by mass of ultra-high-molecular-weight polyethylene having a weight average molecular weight of 4600000 and a Ca content of 30 ppm and 5 parts by mass of high-density polyethylene having a weight average molecular weight of 560000 and a Ca content of 36 ppm was used, and a pre-prepared mixed solvent of 50 parts by mass of liquid paraffin and 25 parts by mass of decalin was mixed with the polyethylene composition such that the total polyethylene resin concentration was 25% by mass, thereby preparing a polyethylene solution. This polyethylene solution was extruded in the same manner as in Comparative Example 10, and a substrate for a liquid filter including a polyolefin microporous membrane was obtained in the same manner, except that the obtained base tape was dried by heating, and subsequently was conveyed on a roller heated to 95 °C while a pressure of 10 kgf/m (0.98 MPa) was applied to the base tape to remove a part of liquid paraffin from the base tape.

### Comparative Example 14

A polyethylene composition obtained by mixing 3 parts by mass of ultra-high-molecular-weight polyethylene having a weight average molecular weight of 4600000 and a Ca content of 30 ppm and 12 parts by mass of high-density polyethylene having a weight average molecular weight of 560000 and a Ca content of 36 ppm was used. A pre-prepared mixed solvent of 60 parts by mass of liquid paraffin and 25 parts by mass of decalin was mixed with the polyethylene composition such that the total polyethylene resin concentration was 15% by mass, thereby preparing a polyethylene solution.

The polyethylene solution was extruded from a die into a sheet shape at a temperature of 160 °C to obtain an extruded product, the extruded product was cooled in a water bath at 25 °C, a water flow was provided on the surface layer of the water bath, and a base tape was produced while preventing the mixed solvent released from a gelled sheet in the water bath and floating on the water surface from re-adhering to the sheet. The base tape was dried at 55 °C for 10 minutes, and then at 95 °C for 10 minutes to remove decalin from the inside of the base tape, and subsequently, the base tape was conveyed on a roller heated to 85 °C while a pressure of 20 kgf/m (1.96 MPa) was applied to the base tape to remove a part of liquid paraffin from the inside of the base tape. Thereafter, the base tape was drawn in the longitudinal direction at a temperature of 100 °C to 6 times (longitudinal drawing) and successively drawn in the width direction at a temperature of 100 °C to 12 times (lateral drawing), and then heat treatment (heat setting) was performed at a temperature of 136 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 45 °C, the base tape was subject to heating treatment while being conveyed on a roller heated to 110 °C, to obtain a substrate for a liquid filter including a polyolefin microporous membrane.

### Comparative Example 15

A substrate for a liquid filter including a polyolefin microporous membrane was obtained in the same manner, except that in Comparative Example 14, a polyethylene composition obtained by mixing 2 parts by mass of ultra-high-molecular-weight polyethylene having a weight average molecular weight of 4600000 and a Ca content of 30 ppm and 18 parts by mass of high-density polyethylene having a weight average molecular weight of 560000 and a Ca content of 36 ppm was used, and a pre-prepared mixed solvent of 55 parts by mass of liquid paraffin and 25 parts by mass of decalin was mixed with the polyethylene composition such that the total polyethylene resin concentration was 20% by mass, thereby preparing a polyethylene solution.

### Comparative Example 16

A substrate for a liquid filter including a polyolefin microporous membrane was obtained in the same manner, except that in Comparative Example 14, the heat treatment (heat setting) temperature after biaxial drawing was set to 142 °C.

### Comparative Example 17

In Comparative Example 14, a polyethylene composition obtained by mixing 6.5 parts by mass of ultra-high-molecular-weight polyethylene having a weight average molecular weight of 4600000 and a Ca content of 30 ppm and 18.5 parts by mass of high-density polyethylene having a weight average molecular weight of 560000 and a Ca content of 36 ppm was used, and a pre-prepared mixed solvent of 50 parts by mass of liquid paraffin and 25 parts by mass of decalin was mixed with the polyethylene composition such that the total polyethylene resin concentration was 25% by mass, thereby preparing a polyethylene solution. This polyethylene solution was used and extruded in the same manner as in Comparative Example 14, and a substrate for a liquid filter including a polyolefin microporous membrane was obtained in the same manner, except that the obtained base tape was dried by heating, and subsequently was conveyed on a roller heated to 95 °C while a pressure of 10 kgf/m (0.98 MPa) was applied to the base tape to remove a part of liquid paraffin from the inside of the base tape.

### Comparative Example 18

A polyethylene composition obtained by mixing 18.4 parts by mass of ultra-high-molecular-weight polyethylene having a weight average molecular weight of 5100000 and a Ca content of 140 ppb and 4.6 parts by mass of high-density polyethylene having a weight average molecular weight of 650000 and a Ca content of 270 ppb was used. A pre-prepared mixed solvent of 74.5 parts by mass of liquid paraffin and 2.5 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 155 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C. while a pressure of 0.05 MPa was applied to the base tape to remove a part of liquid paraffin from the inside of the base tape. Thereafter, the base tape was drawn in the longitudinal direction at a temperature of 115 °C to 5.8 times (longitudinal drawing) and successively drawn in the width direction at a temperature of 105 °C to 13 times (lateral drawing), and then heat treatment (heat setting) was performed at 130 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 19

A polyethylene composition obtained by mixing 18.4 parts by mass of ultra-high-molecular-weight polyethylene having a weight average molecular weight of 5100000 and a Ca content of 140 ppb and 4.6 parts by mass of high-density polyethylene having a weight average molecular weight of 650000 and a Ca content of 270 ppb was used. A pre-prepared mixed solvent of 75.9 parts by mass of liquid paraffin and 1.1 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 158 °C to obtain an extruded product, the extruded product was cooled in a water bath at 18 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 95 °C to 5.8 times (longitudinal drawing) and successively drawn in the width direction at a temperature of 105 °C to 13 times (lateral drawing), and then heat treatment (heat setting) was performed at 140 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 20

A polyethylene composition obtained by mixing 12.5 parts by mass of ultra-high-molecular-weight polyethylene having a weight average molecular weight of 5100000 and a Ca content of 140 ppb and 12.5 parts by mass of high-density polyethylene having a weight average molecular weight of 650000 and a Ca content of 270 ppb was used. A pre-prepared mixed solvent of 72.5 parts by mass of liquid paraffin and 2.5 parts by mass of decalin was mixed with the polyethylene composition such that the total polyethylene resin concentration was 25% by mass, thereby preparing a polyethylene solution.

The polyethylene solution was extruded from a die into a sheet shape at a temperature of 156 °C to obtain an extruded product, the extruded product was cooled in a water bath at 18 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 110 °C while a pressure of 0.05 MPa was applied to the base tape to remove a part of liquid paraffin from the inside of the base tape. Thereafter, the base tape was drawn in the longitudinal direction at a temperature of 115 °C to 5.8 times (longitudinal drawing) and successively drawn in the width direction at a temperature of 105 °C to 13 times (lateral drawing), and then heat treatment (heat setting) was performed at 115 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 21

A polyethylene composition obtained by mixing 6 parts by mass of ultra-high-molecular-weight polyethylene having a weight average molecular weight of 5100000 and a Ca content of 140 ppb and 24 parts by mass of high-density polyethylene having a weight average molecular weight of 650000 and a Ca content of 270 ppb was used. A pre-prepared mixed solvent of 67.5 parts by mass of liquid paraffin and 2.5 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 164 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 115 °C to 5.8 times (longitudinal drawing) and successively drawn in the width direction at a temperature of 105 °C to 13 times (lateral drawing), and then heat treatment (heat setting) was performed at 140 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 125 °C, to obtain a substrate for a liquid filter including a polyolefin microporous membrane.

### Comparative Example 22

A polyethylene composition obtained by mixing 4.6 parts by mass of ultra-high-molecular-weight polyethylene having a weight average molecular weight of 5100000 and a Ca content of 140 ppb and 18.4 parts by mass of high-density polyethylene having a weight average molecular weight of 650000 and a Ca content of 270 ppb was used. A pre-prepared mixed solvent of 74.5 parts by mass of liquid paraffin and 2.5 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 164 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 115 °C to 5.8 times (longitudinal drawing) and successively drawn in the width direction at a temperature of 105 °C to 13 times (lateral drawing), and then heat treatment (heat setting) was performed at 128 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 23

A polyethylene composition obtained by mixing 4.6 parts by mass of ultra-high-molecular-weight polyethylene having a weight average molecular weight of 5100000 and a Ca content of 140 ppb and 18.4 parts by mass of high-density polyethylene having a weight average molecular weight of 650000 and a Ca content of 270 ppb was used. A pre-prepared mixed solvent of 74.5 parts by mass of liquid paraffin and 2.5 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 164 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 115 °C to 7 times (longitudinal drawing) and successively drawn in the width direction at a temperature of 105 °C to 11 times (lateral drawing), and then heat treatment (heat setting) was performed at 125 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 24

A polyethylene composition obtained by mixing 10.0 parts by mass of ultra-high-molecular-weight polyethylene having a weight average molecular weight of 5100000 and a Ca content of 140 ppb and 10.0 parts by mass of high-density polyethylene having a weight average molecular weight of 650000 and a Ca content of 270 ppb was used. A pre-prepared mixed solvent of 77.3 parts by mass of liquid paraffin and 2.7 parts by mass of decalin was mixed with the polyethylene composition such that the total polyethylene resin concentration was 20% by mass, thereby preparing a polyethylene solution.

The polyethylene solution was extruded from a die into a sheet shape at a temperature of 156 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 115 °C to 7 times (longitudinal drawing) and successively drawn in the width direction at a temperature of 105 °C to 13 times (lateral drawing), and then heat treatment (heat setting) was performed at 135 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 25

A polyethylene composition obtained by mixing 24 parts by mass of ultra-high-molecular-weight polyethylene having a weight average molecular weight of 5100000 and a Ca content of 140 ppb and 6 parts by mass of high-density polyethylene having a weight average molecular weight of 650000 and a Ca content of 270 ppb was used. A pre-prepared mixed solvent of 67.7 parts by mass of liquid paraffin and 2.3 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 158 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 115 °C to 7 times (longitudinal drawing) and successively drawn in the width direction at a temperature of 105 °C to 9 times (lateral drawing), and then heat treatment (heat setting) was performed at 130 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 105 °C, to obtain a substrate for a liquid filter including a polyolefin microporous membrane.

### Comparative Example 26

A polyethylene composition obtained by mixing 15 parts by mass of ultra-high-molecular-weight polyethylene having a weight average molecular weight of 4600000 and a Ca content of 30 ppm and 15 parts by mass of high-density polyethylene having a weight average molecular weight of 560000 and a Ca content of 36 ppm was used. A pre-prepared mixed solvent of 67.5 parts by mass of liquid paraffin and 2.5 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 155 °C to obtain an extruded product, the extruded product was cooled in a water bath at 20 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 90 °C to 5.9 times (longitudinal drawing) and successively drawn in the width direction at a temperature of 105 °C to 13 times (lateral drawing), and then heat treatment (heat setting) was performed at 130 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

### Comparative Example 27

A polyethylene composition obtained by mixing 18 parts by mass of ultra-high-molecular-weight polyethylene having a weight average molecular weight of 4600000 and a Ca content of 30 ppm and 5 parts by mass of high-density polyethylene having a weight average molecular weight of 560000 and a Ca content of 36 ppm was used. A pre-prepared mixed solvent of 75.9 parts by mass of liquid paraffin and 1.1 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 158 °C to obtain an extruded product, the extruded product was cooled in a water bath at 18 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 90 °C while a pressure of 0.05 MPa was applied to the base tape to remove a part of liquid paraffin from the inside of the base tape. Thereafter, the base tape was drawn in the longitudinal direction at a temperature of 90 °C to 7.0 times (longitudinal drawing) and successively drawn in the width direction at a temperature of 105 °C to 13 times (lateral drawing), and then heat treatment (heat setting) was performed at 130 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 100 °C, to obtain a substrate for a liquid filter including a polyolefin microporous membrane.

### Comparative Example 28

A polyethylene composition obtained by mixing 18 parts by mass of ultra-high-molecular-weight polyethylene having a weight average molecular weight of 4600000 and a Ca content of 30 ppm and 5 parts by mass of high-density polyethylene having a weight average molecular weight of 560000 and a Ca content of 36 ppm was used. A pre-prepared mixed solvent of 75.9 parts by mass of liquid paraffin and 1.1 parts by mass of decalin was mixed with the polyethylene composition such that the total polyethylene resin concentration was 23% by mass, thereby preparing a polyethylene solution.

The polyethylene solution was extruded from a die into a sheet shape at a temperature of 156 °C to obtain an extruded product, the extruded product was cooled in a water bath at 18 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 110 °C while a pressure of 0.05 MPa was applied to the base tape to remove a part of liquid paraffin from the inside of the base tape. Thereafter, the base tape was drawn in the longitudinal direction at a temperature of 105 °C to 6.5 times (longitudinal drawing) and successively drawn in the width direction at a temperature of 115 °C to 13 times (lateral drawing), and then heat treatment (heat setting) was performed at 130 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 100 °C, to obtain a substrate for a liquid filter including a polyolefin microporous membrane.

### Comparative Example 29

A polyethylene composition obtained by mixing 15 parts by mass of ultra-high-molecular-weight polyethylene having a weight average molecular weight of 4600000 and a Ca content of 30 ppm and 15 parts by mass of high-density polyethylene having a weight average molecular weight of 560000 and a Ca content of 36 ppm was used. A pre-prepared mixed solvent of 67.5 parts by mass of liquid paraffin and 2.5 parts by mass of decalin was mixed with the polyethylene composition such that the total polyethylene resin concentration was 30% by mass, thereby preparing a polyethylene solution.

The polyethylene solution was extruded from a die into a sheet shape at a temperature of 164 °C to obtain an extruded product, the extruded product was cooled in a water bath at 16 °C, a water flow was provided on the surface layer of the water bath, and a base tape was produced while preventing the mixed solvent released from a gelled sheet in the water bath and floating on the water surface from re-adhering to the sheet. The base tape was dried at 60 °C for 7 minutes, and then at 95 °C for 7 minutes to remove decalin from the inside of the base tape, and subsequently, the base tape was conveyed on a roller heated to 30 °C while a pressure of 0.05 MPa was applied to the base tape to remove a part of liquid paraffin from the inside of the base tape. Thereafter, the base tape was drawn in the longitudinal direction at a temperature of 90 °C to 5.9 times (longitudinal drawing) and successively drawn in the width direction at a temperature of 105 °C to 13 times (lateral drawing), and then heat treatment (heat setting) was performed at 120 °C.

Next, the heat-treated base tape was immersed in a two-tank methylene chloride bath successively for 30 seconds per tank, thereby extracting liquid paraffin. In a case in which the tank where immersion is started is defined as a first tank, and the tank where immersion is finished is defined as a second tank, the purity of the washing solvent is (low) first tank<second tank (high). Thereafter, methylene chloride was removed by drying at 40 °C, the base tape was subject to heating treatment while being conveyed on a roller heated to 120 °C, to obtain a substrate for a liquid filter including a polyolefin microporous membrane.

TABLE 1

| | Average value | | | | Coefficient of variation | | | | | | Amount of |
|---|---|---|---|---|---|---|---|---|---|---|---|
| | Membrane | | Pore | | Water | | | | Variation in | | dissolution |
| | thickness | Porosity | diameter | Water flow rate | flow | Pore | Membrane | | filtration | Collection | of Ca |
| | (μm) | (%) | (nm) | (L/min./ft²/psi) | rate | diameter | thickness | Porosity | time | efficiency | μg/m² |
| Example 1 | 6 | 47 | 16 | 0.015 | 0.039 | 0.032 | 0.021 | 0.044 | A | A | Less than 1 |
| Example 2 | 6 | 43 | 14 | 0.008 | 0.060 | 0.058 | 0.057 | 0.068 | A | A | Less than 1 |
| Example 3 | 6 | 41 | 14 | 0.006 | 0.088 | 0.091 | 0.072 | 0.083 | A | A | Less than 1 |
| Example 4 | 6 | 53 | 18 | 0.025 | 0.040 | 0.032 | 0.043 | 0.035 | A | A | Less than 1 |
| Example 5 | 9 | 51 | 18 | 0.016 | 0.044 | 0.033 | 0.040 | 0.043 | A | A | Less than 1 |
| Example 6 | 12 | 57 | 50 | 0.152 | 0.062 | 0.050 | 0.033 | 0.066 | A | C | 60 |
| Example 7 | 13 | 56 | 30 | 0.051 | 0.020 | 0.029 | 0.043 | 0.035 | A | B | 65 |
| Example 8 | 11 | 51 | 20 | 0.018 | 0.036 | 0.025 | 0.031 | 0.028 | A | A | 62 |
| Example 9 | 10 | 50 | 18 | 0.014 | 0.033 | 0.031 | 0.023 | 0.030 | A | A | 64 |
| Example 10 | 9 | 49 | 16 | 0.010 | 0.045 | 0.044 | 0.030 | 0.027 | A | A | 57 |
| Comparative | 6 | 43 | 16 | 0.012 | 0.108 | 0.117 | 0.112 | 0.113 | B | A | Less than 1 |
| Example 1 | | | | | | | | | | | |
| Comparative | 5 | 40 | 14 | 0.005 | 0.151 | 0.145 | 0.117 | 0.166 | B | A | Less than 1 |
| Example 2 | | | | | | | | | | | |
| Comparative | 5 | 40 | 16 | 0.008 | 0.197 | 0.201 | 0.111 | 0.189 | B | A | Less than 1 |
| Example 3 | | | | | | | | | | | |
| Comparative | 12 | 54 | 50 | 0.122 | 0.140 | 0.157 | 0.118 | 0.155 | B | C | 62 |
| Example 4 | | | | | | | | | | | |
| Comparative | 11 | 49 | 20 | 0.017 | 0.107 | 0.117 | 0.108 | 0.115 | B | A | 61 |
| Example 5 | | | | | | | | | | | |
| Comparative | 12 | 53 | 30 | 0.039 | 0.112 | 0.116 | 0.105 | 0.121 | B | B | 58 |
| Example 6 | | | | | | | | | | | |
| Comparative | 8 | 47 | 18 | 0.014 | 0.161 | 0.154 | 0.112 | 0.170 | B | A | 61 |
| Example 7 | | | | | | | | | | | |
| Comparative | 13 | 50 | 20 | 0.015 | 0.109 | 0.113 | 0.108 | 0.117 | B | A | 55 |
| Example 8 | | | | | | | | | | | |
| Comparative | 10 | 46 | 17 | 0.012 | 0.177 | 0.186 | 0.122 | 0.161 | B | A | 56 |
| Example 9 | | | | | | | | | | | |
| Comparative | 12 | 54 | 25 | 0.028 | 0.120 | 0.116 | 0.107 | 0.114 | B | B | 54 |
| Example 10 | | | | | | | | | | | |

TABLE 2

| | Average value | | | | Coefficient of variation | | | | | | Amount of |
|---|---|---|---|---|---|---|---|---|---|---|---|
| | Membrane | | Pore | | Water | | | | Variation in | | dissolution |
| | thickness | Porosity | diameter | Water flow rate | flow | Pore | Membrane | | filtration | Collection | of Ca |
| | (μm) | (%) | (nm) | (L/min./ft²/psi) | rate | diameter | thickness | Porosity | time | efficiency | μg/m² |
| Comparative | 12 | 56 | 30 | 0.042 | 0.109 | 0.111 | 0.109 | 0.122 | B | B | 49 |
| Example 11 | | | | | | | | | | | |
| Comparative | 11 | 57 | 35 | 0.053 | 0.110 | 0.115 | 0.116 | 0.137 | B | B | 56 |
| Example 12 | | | | | | | | | | | |
| Comparative | 13 | 52 | 18 | 0.009 | 0.122 | 0.127 | 0.114 | 0.141 | B | A | 52 |
| Example 13 | | | | | | | | | | | |
| Comparative | 11 | 55 | 30 | 0.047 | 0.113 | 0.110 | 0.121 | 0.119 | B | B | 57 |
| Example 14 | | | | | | | | | | | |
| Comparative | 11 | 53 | 25 | 0.022 | 0.122 | 0.126 | 0.104 | 0.111 | B | B | 58 |
| Example 15 | | | | | | | | | | | |
| Comparative | 14 | 60 | 50 | 0.163 | 0.155 | 0.164 | 0.115 | 0.142 | B | C | 60 |
| Example 16 | | | | | | | | | | | |
| Comparative | 9 | 51 | 20 | 0.019 | 0.110 | 0.109 | 0.107 | 0.123 | B | A | 63 |
| Example 17 | | | | | | | | | | | |
| Comparative | 10 | 50 | 30 | 0.018 | 0.112 | 0.118 | 0.109 | 0.117 | B | B | Less than 1 |
| Example 18 | | | | | | | | | | | |
| Comparative | 20 | 50 | 40 | 0.027 | 0.117 | 0.122 | 0.116 | 0.111 | B | C | Less than 1 |
| Example 19 | | | | | | | | | | | |
| Comparative | 5 | 42 | 15 | 0.007 | 0.161 | 0.157 | 0.128 | 0.152 | B | A | Less than 1 |
| Example 20 | | | | | | | | | | | |
| Comparative | 25 | 60 | 50 | 0.107 | 0.133 | 0.134 | 0.109 | 0.149 | B | C | Less than 1 |
| Example 21 | | | | | | | | | | | |
| Comparative | 5 | 50 | 30 | 0.028 | 0.109 | 0.110 | 0.107 | 0.112 | B | B | Less than 1 |
| Example 22 | | | | | | | | | | | |
| Comparative | 11 | 54 | 20 | 0.026 | 0.112 | 0.125 | 0.109 | 0.113 | B | A | Less than 1 |
| Example 23 | | | | | | | | | | | |
| Comparative | 30 | 65 | 50 | 0.121 | 0.141 | 0.151 | 0.123 | 0.138 | B | C | Less than 1 |
| Example 24 | | | | | | | | | | | |
| Comparative | 7 | 48 | 15 | 0.007 | 0.158 | 0.150 | 0.121 | 0.155 | B | A | Less than 1 |
| Example 25 | | | | | | | | | | | |
| Comparative | 10 | 49 | 16 | 0.018 | 0.149 | 0.144 | 0.104 | 0.161 | B | A | 48 |
| Example 26 | | | | | | | | | | | |
| Comparative | 12 | 59 | 16 | 0.016 | 0.152 | 0.157 | 0.114 | 0.160 | B | A | 56 |
| Example 27 | | | | | | | | | | | |
| Comparative | 12 | 60 | 17 | 0.020 | 0.154 | 0.144 | 0.108 | 0.162 | B | A | 62 |
| Example 28 | | | | | | | | | | | |
| Comparative | 13 | 39 | 13 | 0.007 | 0.167 | 0.159 | 0.117 | 0.154 | B | A | 65 |
| Example 29 | | | | | | | | | | | |

The following can be seen from the evaluation results shown in Tables 1 and 2.

It is found that the substrate for a liquid filter including the polyolefin microporous membrane of each of Examples 1 to 10 having a coefficient of variation in water flow rate of 0.100 or less is excellent variation in filtration time as compared with the substrate for a liquid filter including the polyolefin microporous membrane of each of Comparative Examples 1 to 29 having a coefficient of variation in water flow rate of more than 0.100.

It is found that the substrate for a liquid filter including a polyolefin microporous membrane of each of Examples 1 to 5 in which the Ca content contained in the polyethylene used for the raw material is less than 1 ppm has a suppressed amount of dissolution of Ca as compared with the substrate for a liquid filter including a polyolefin microporous membrane of each of Examples 6 to 10 in which the Ca content is 1 ppm or more.

It is found that the substrate for a liquid filter including a polyolefin microporous membrane of each of Examples 1 to 5 and 8 to 10 in which the average value of pore diameters is 20 nm or less is superior in collection efficiency to the substrate for a liquid filter including a polyolefin microporous membrane of each of Examples 6 and 7 in which the average value of pore diameters is more than 20 nm.

The entire contents of the disclosures by Japanese Patent Application No. 2022-120889 filed on Jul. 28, 2022 are incorporated herein by reference.

All the literature, patent application, and technical standards cited herein are also herein incorporated to the same extent as provided for specifically and severally with respect to an individual literature, patent application, and technical standard to the effect that the same should be so incorporated by reference.

1. A substrate for a liquid filter, the substrate comprising a polyolefin microporous membrane, wherein:
an average value of pore diameters of the polyolefin microporous membrane is from 1 nm to 50 nm,
an average value of water flow rates of the polyolefin microporous membrane is from 0.003 L/min/ft²/psi to 0.180 L/min/ft²/psi, and
a coefficient of variation in water flow rate of the polyolefin microporous membrane is 0.100 or less.

2. The substrate for a liquid filter according to claim 1, wherein a coefficient of variation in pore diameter of the polyolefin microporous membrane is 0.100 or less.

3. The substrate for a liquid filter according to claim 1, wherein a coefficient of variation in membrane thickness of the polyolefin microporous membrane is 0.100 or less.

4. The substrate for a liquid filter according to claim 1, wherein a coefficient of variation in porosity of the polyolefin microporous membrane is 0.100 or less.

5. The substrate for a liquid filter according to claim 1, wherein an average value of membrane thickness of the polyolefin microporous membrane is from 3 μm to 20 μm.

6. The substrate for a liquid filter according to claim 1, wherein an average value of porosity of the polyolefin microporous membrane is from 35% to 60%.
